(19) United States
(12) Patent Application Publication
(10) Pub. No.: US 2025/0176456 A1
(43) Pub. Date: Jun. 5, 2025

(54) MANURE LAGOON AGITATION DEVICE

(71) Applicant: BAZOOKA-FARMSTAR, LLC, Washington, IA (US)

(72) Inventors: Jeffery William Huber, Washington, IA (US); Logan Patrick Carter, Iowa City, IA (US); Jason Bruce Albright, Wellman, IA (US); Phillip David Minino, Washington, IA (US)

(21) Appl. No.: 18/959,096

(22) Filed: Nov. 25, 2024

Related U.S. Application Data
(60) Provisional application No. 63/604,222, filed on Nov. 30, 2023.

(51) Int. Cl. A01C 3/02

(52) U.S. Cl. CPC A01C 3/026

(57) ABSTRACT

An example manure lagoon agitation device can include a spinning drum rotatably mounted to a floating frame. The spinning drum includes a plurality of blades oriented to direct material toward a center of the drum and project material outward. A moveable cover with an adjustable chute controls flow direction of projected material. The device includes lift cylinders to position the drum between storage and operating positions. The spinning drum can operate at variable speeds and depths for breaking up solids or projecting liquid. The device may include protection features like skids and pivoting flails to prevent damage from obstacles.

### RELATED APPLICATION(S)

This patent application is related to U.S. Patent Application No. 63/604,222 filed on Nov. 30, 2023, the entirety of which is hereby incorporated by reference.

### BACKGROUND

In open pit storage, like lagoons or tanks where solids such as livestock bedding materials and organic matter are stored, can pile up or cause floating masses on top of the liquid. The solids tend to get pushed up the banks over the course of time or get stuck on the banks when the liquid is being pumped out of the lagoon and the liquid level is decreased. Sand can also pile on the bottom of the lagoon and eventually create islands that are difficult to break up with conventional means of manure agitation.

### SUMMARY

In one aspect, an example manure lagoon agitation device can include a frame configured to float in a manure lagoon, a spinning drum rotatably mounted to the frame, a plurality of blades mounted on the spinning drum, wherein at least some of the blades are oriented at an angle to direct material toward a center of the spinning drum, and a cover positioned adjacent the spinning drum to control flow of material projected from the spinning drum.

In another aspect, an example method of agitating material in a manure lagoon can include rotating a spinning drum mounted to a floating frame, wherein the spinning drum includes a plurality of blades, directing material toward a center of the spinning drum using angled blades mounted on the spinning drum, and controlling flow of material projected from the spinning drum using an adjustable cover.

### DESCRIPTION OF DRAWINGS

FIG. 1 shows an example spinning drum.

FIG. 2 shows the spinning drum of FIG. 1 coupled to an example amphibious vehicle.

FIG. 3 shows another view of the spinning drum of FIG. 1.

FIG. 4 shows the amphibious vehicle of FIG. 2 with the spinning drum in an operating mode.

FIG. 5 shows the amphibious vehicle of FIG. 2 with the spinning drum in a storage mode.

FIG. 6 shows an example spinning drum with blades running in the direction of rotation for cutting, with angled ends and perpendicular center blades for projecting material.

FIG. 7 shows an example spinning drum with outer blades that cut and direct material to the centerline.

FIG. 8 shows an example spinning drum with a combination design with both cutting and projecting capabilities.

FIG. 9 shows an example spinning drum focused on urging material toward the center for outward projection.

FIG. 10 shows an example spinning drum with replaceable center paddles.

FIG. 11 shows an example spinning drum with material-moving features.

FIG. 12 shows an example rear cover design with a moveable chute to control material flow direction.

FIG. 13 shows another view of the cover of FIG. 12.

FIG. 14 shows another view of the cover of FIG. 12.

FIG. 15 shows an example sweeping peak cover that focuses flow volume to the middle.

FIG. 16 shows another view of the cover of FIG. 15.

FIG. 17 shows another view of the cover of FIG. 15.

FIG. 18 shows an example involute-shaped cover design with increasing diameter for controlling material flow.

FIG. 19 shows another view of the cover of FIG. 18.

FIG. 20 shows another view of the cover of FIG. 18.

FIG. 21 shows an example protection skid mounted outside the cutting diameter.

FIG. 22 shows example flail components that pivot or bend when encountering obstacles.

FIG. 23 shows example serrated blade designs that can be permanent or replaceable.

FIG. 24 shows an example cover that includes hydraulic cylinder actuation of the cover and/or chutes for adjusting flow patterns.

FIG. 25 shows another view of the cover of FIG. 24.

FIG. 26 shows another view of the cover of FIG. 24.

FIG. 27 shows another view of the cover of FIG. 24.

FIG. 28 shows another view of the cover of FIG. 24.

FIG. 29 shows the vehicle of FIG. 2 operating in a manure lagoon.

FIG. 30 shows another view of the manure lagoon of FIG. 29.

FIG. 31 shows another view of the manure lagoon of FIG. 29.

### DETAILED DESCRIPTION

The concept includes a device that is made for attachment to a manure agitation boat, whether amphibious or otherwise, but could be attached to any floating vehicle that maneuvers in the liquid manure. One non-limiting example of such a manure agitation boat is described in U.S. patent application Ser. No. 17/351,841 filed on Jun. 18, 2021, the entirety of which is hereby incorporated by reference.

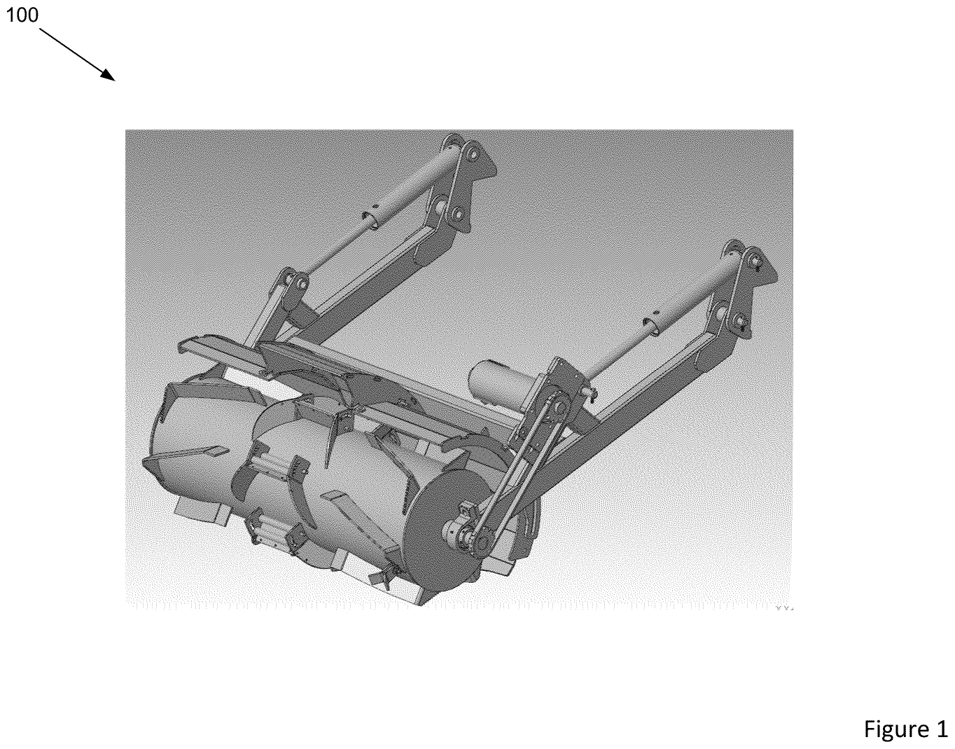

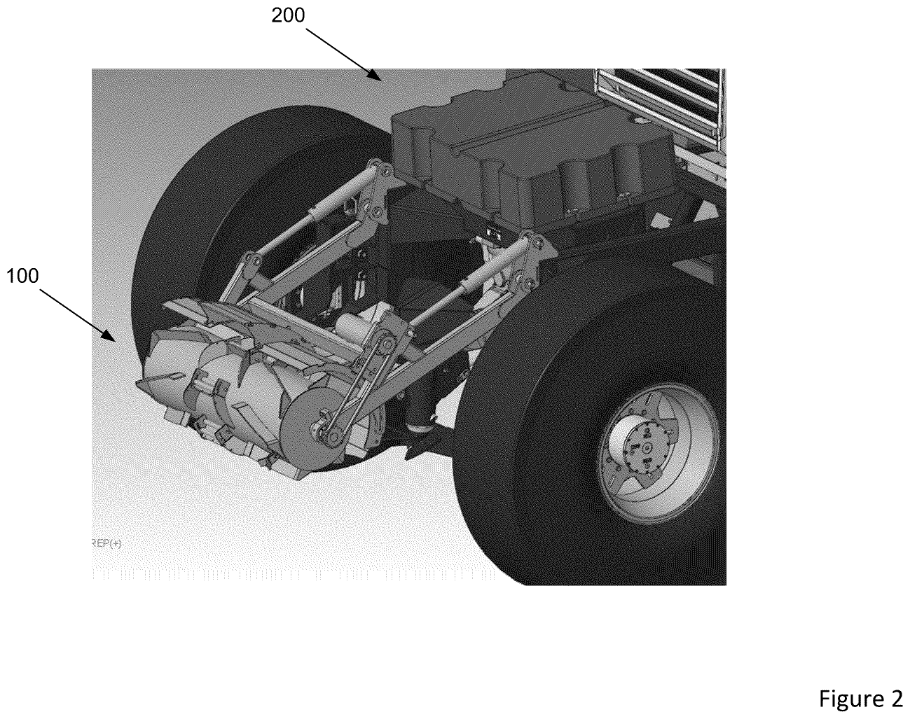

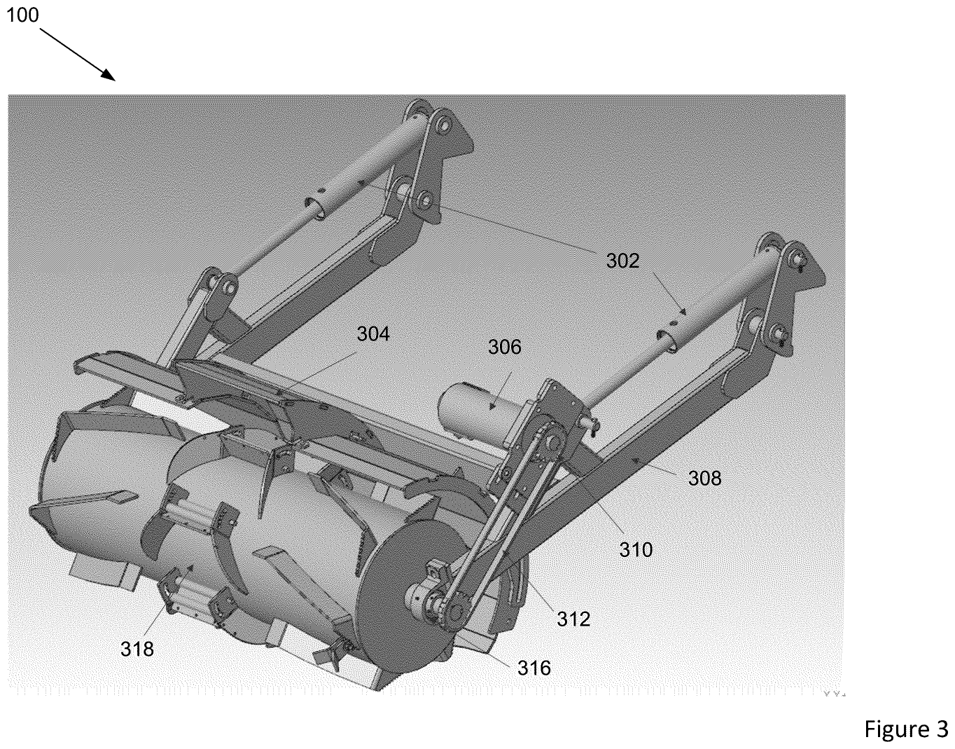

Referring now to FIGS. 1-5, in the examples provided herein, the amphibious vehicle 200 has a frame that includes a plurality of floatable members. Mounted to the frame is one or more power sources. Also mounted to the frame and connected to the power source are a plurality of propellers, with each of the plurality of propellers having a thrust vector configured to be adjusted to provide agitation and propulsion. In addition, mounted to the frame are a plurality of ground engaging devices and one or more pumps.

In addition to, or alternatively to, propellers, nozzles, and/or conduits described in U.S. patent application Ser. No. 17/351,841, other devices may be used to provide or assist with agitation. As examples augers, spinning blades, scrapers, a loader bucket, or the like may be used to draw in solids or liquids from the lagoon toward the vehicle to provide material to be agitated by the vehicle. The other devices would be fixed or adjustably connected to the frame. For example, a scraper is connected to an extendable arm and is used to pull solids from the surface of the lagoon or the banks toward the agitation devices of the vehicle. Also, connected to the frame could be a tail flail or flail mower type. The tail flail is used to clean banks or could be submerged to break up solids from the bottom of the lagoon.

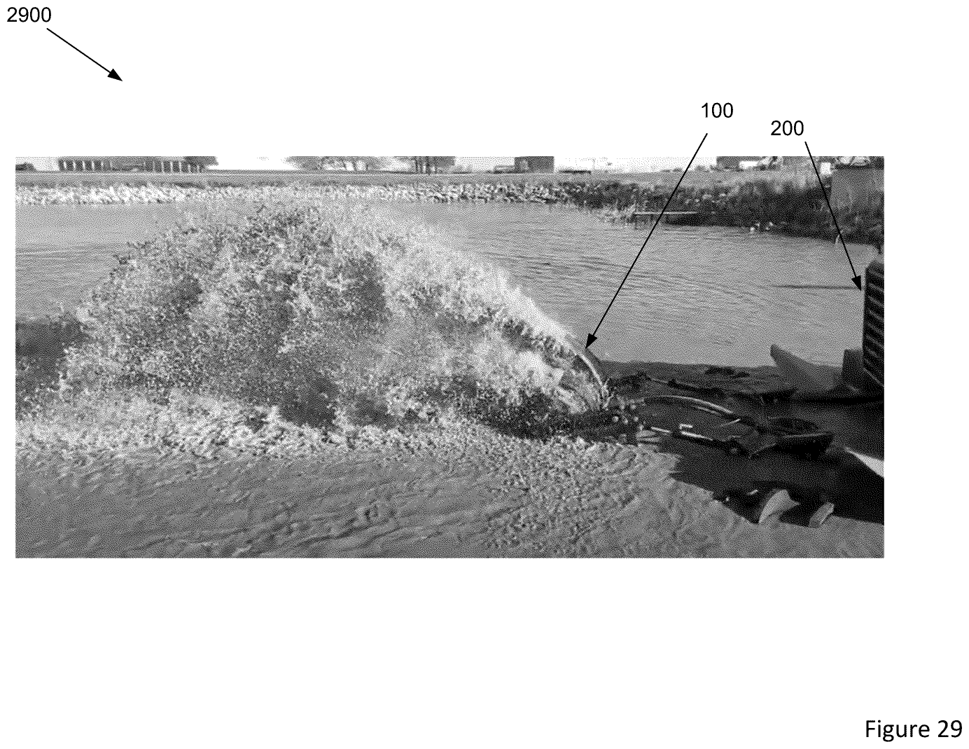

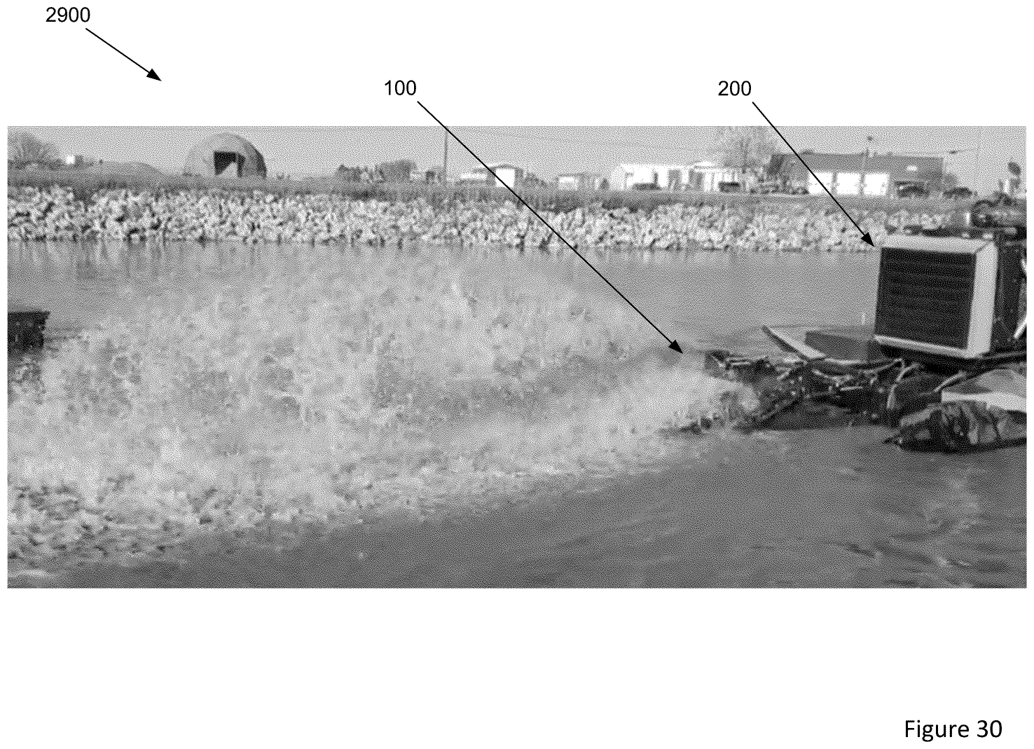

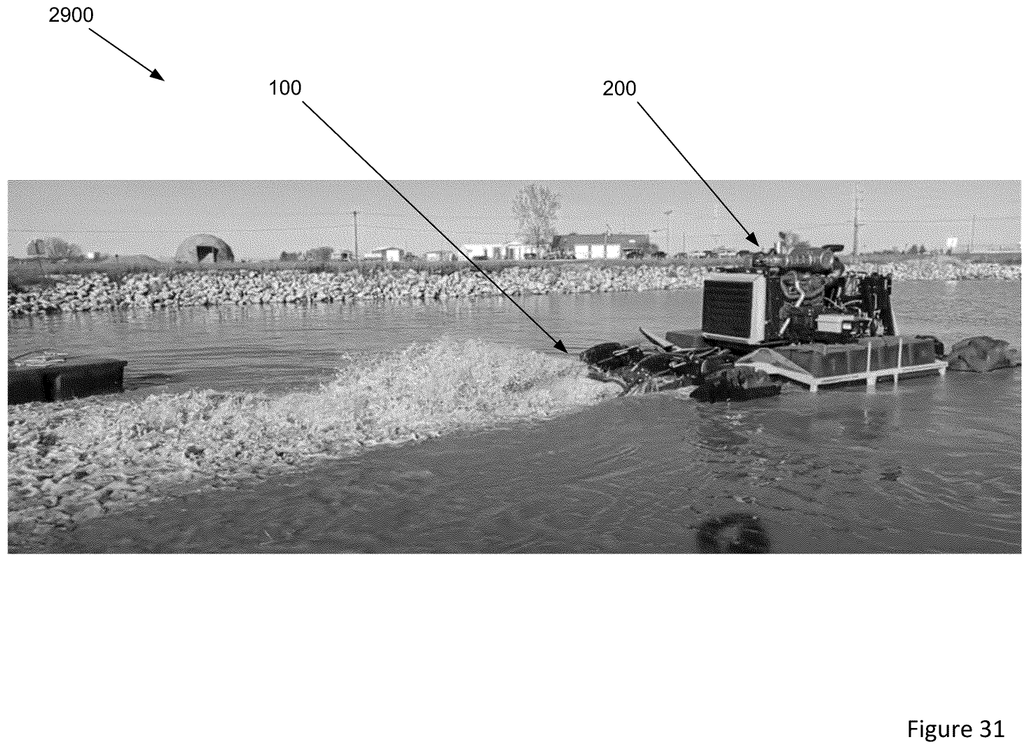

In this example, the vehicle 200 is a manure agitation boat used to agitate manure in a lagoon 2900. See FIGS. 29-31. Other embodiments of the present concept would include attaching the device to any piece of heavy equipment like a tractor loader arm or 3-point, bulldozer, backhoe, or skid steer when there isn't a need for flotation, like in a shallow lagoon or if only operating from on top of the banks to break up the material, with the machine never entering the liquid.

As depicted in the accompany drawings, which are hereby incorporated by reference, one current embodiment of the vehicle 200 includes a spinning drum 100. In the example shown, the spinning drum 100 includes lift cylinders 302, an aimable chut 304, and a drive motor 306 to spin a spinning cutter (or projecting device) 318. The spinning drum 100 also includes a sprocket 310, a chain 312, and mount bearings 316.

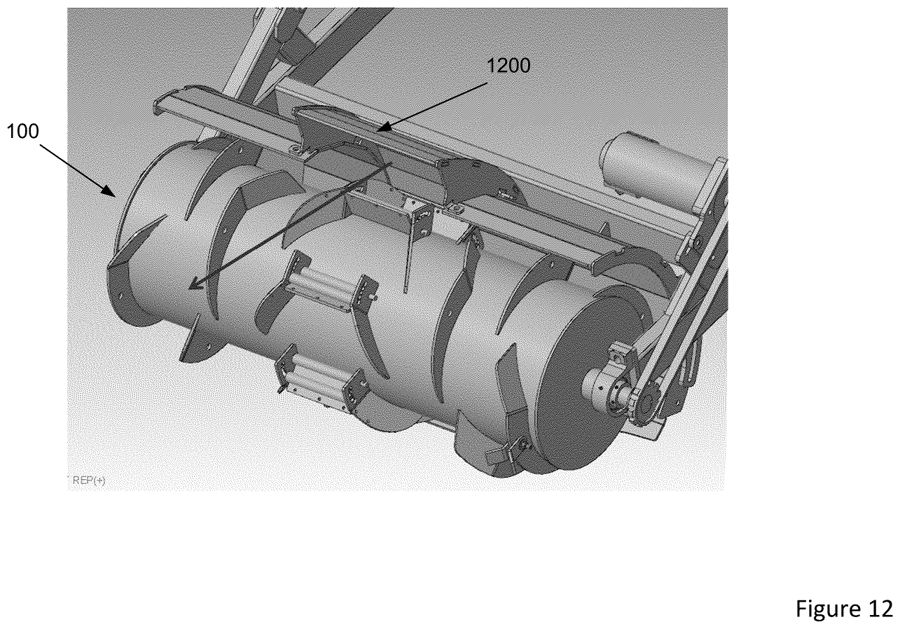

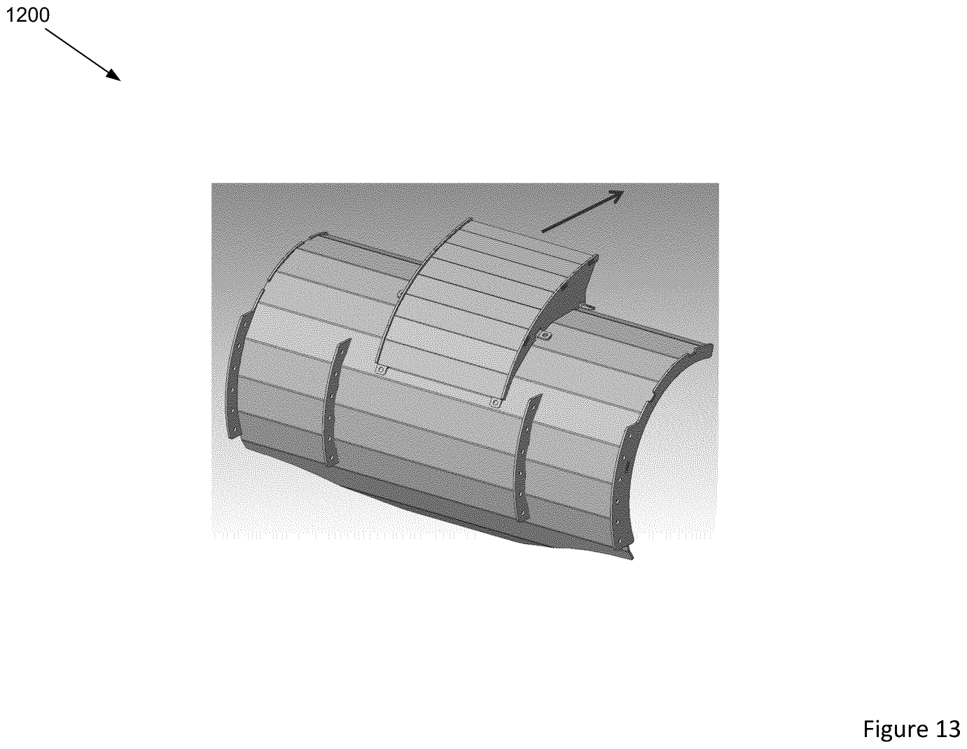

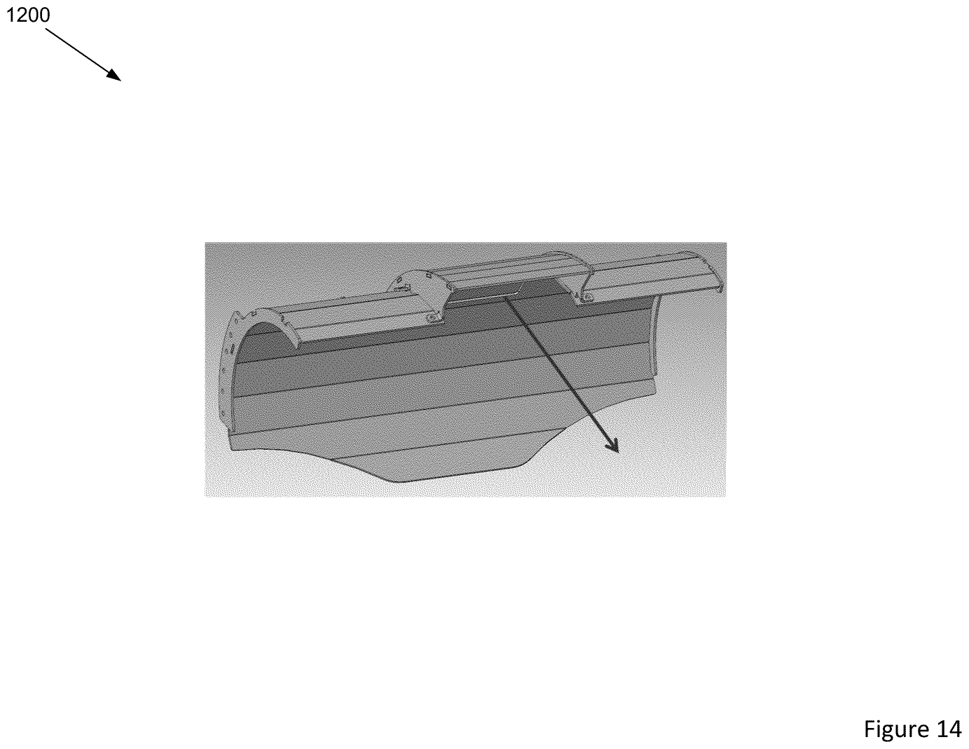

In some examples, the spinning drum 100 includes a rear cover 1200 to control the flow of solid or liquid material and keep it from being expelled towards the machine or operator. See FIGS. 12-14. The cover may be fully moveable to further control the flow direction of material or have any smaller portion of it moveable to only control a certain percentage of the total material's flow direction. Included on the cover may be a flow guide, such as a fixed or moveable chute to further control the flow direction of projected material.

The cover serves to contain flow of material and focus it to a direction best suited for the application. Shown here having a raised center area, which allows flow to release from the hood at a higher angle or trajectory, making it shoot further away than the material on the sides. A variety of mounting positions for the hood can be provided, which could be manually adjustable or using controls such as hydraulics to adjust the position. This could also be automated for aiming based on sensor feedback.

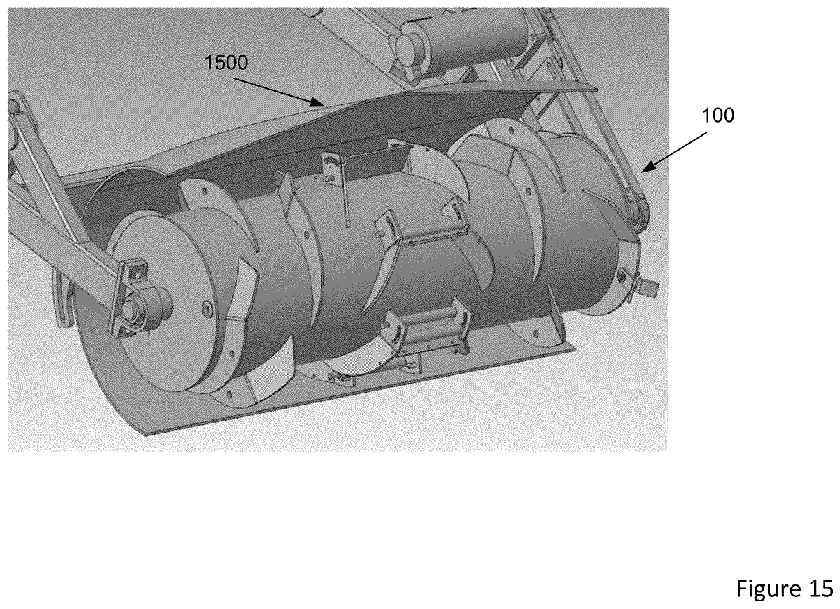

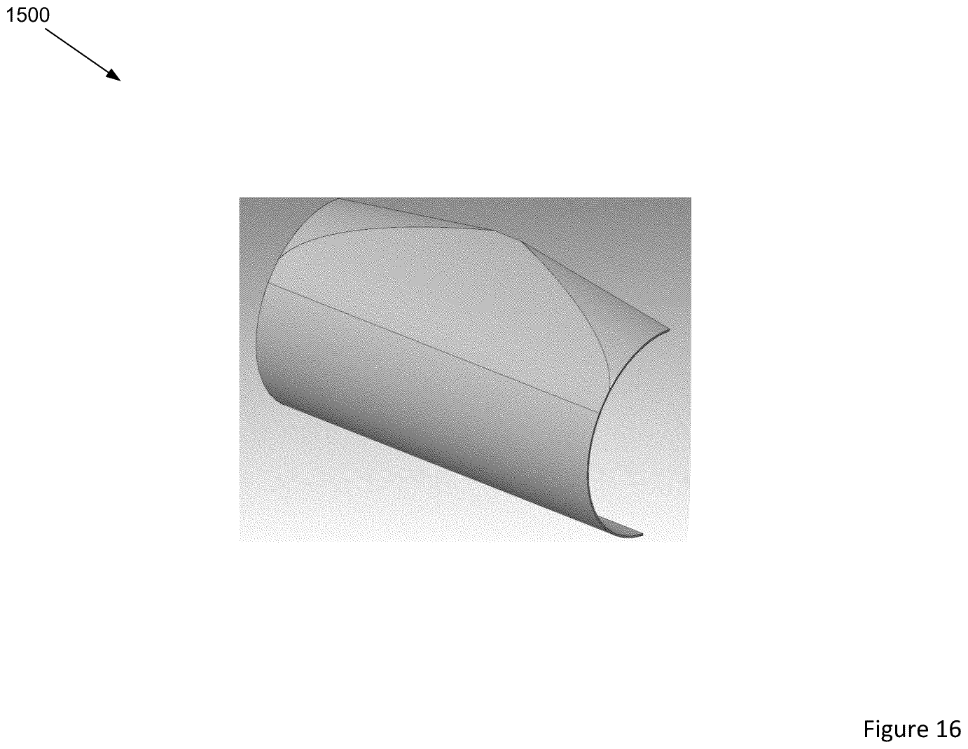

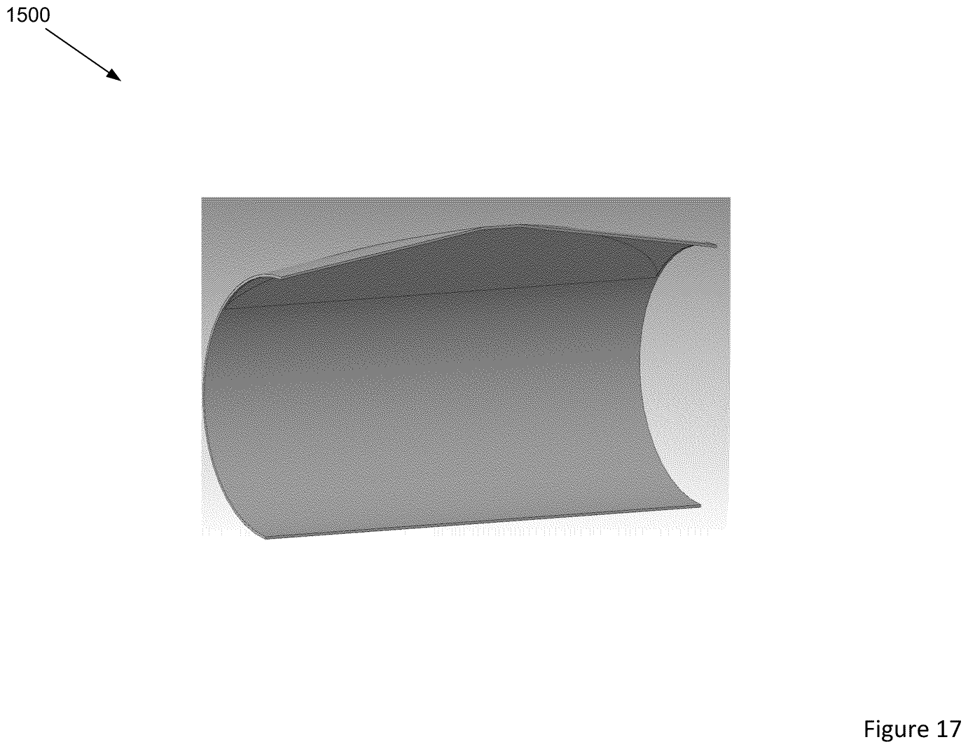

In an alternative embodiment, a sweeping peak cover 1500 focuses more of the flow volume to the middle of the system and ensures only the central portion of the flow pattern to release higher and shoot further. See FIGS. 15-17. The sides of the flow will release at a lower trajectory than the center. The dropped front edges could be made from another material, like rubber, so it can take on shapes that are difficult to make from steel.

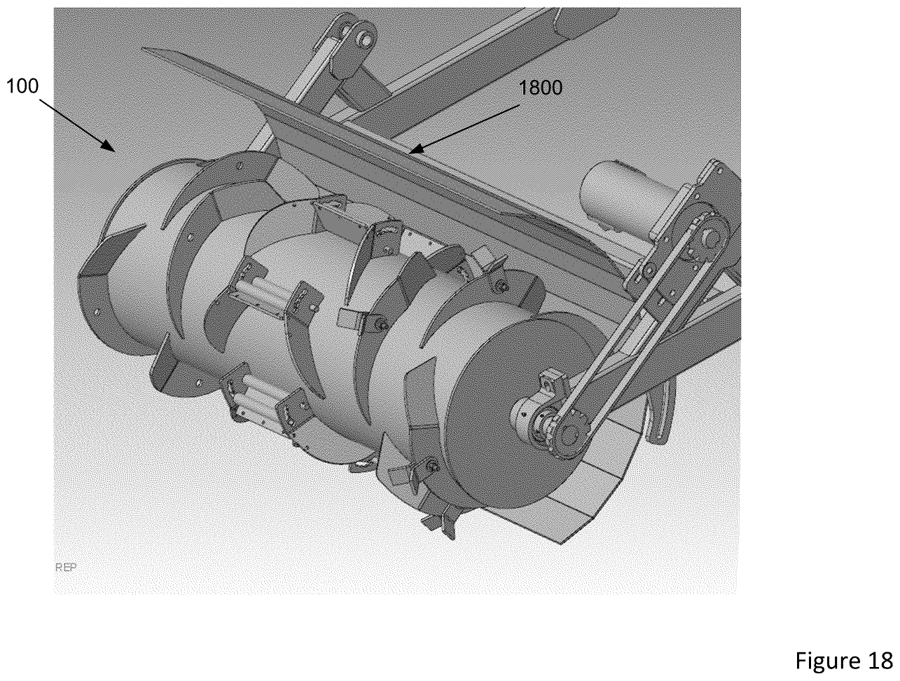

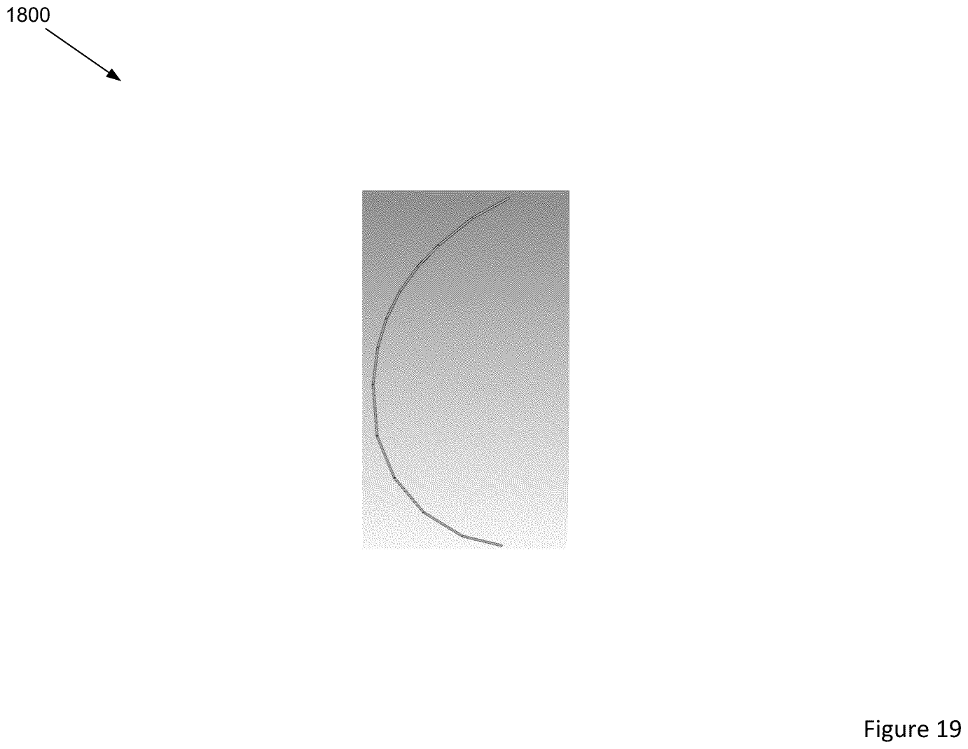

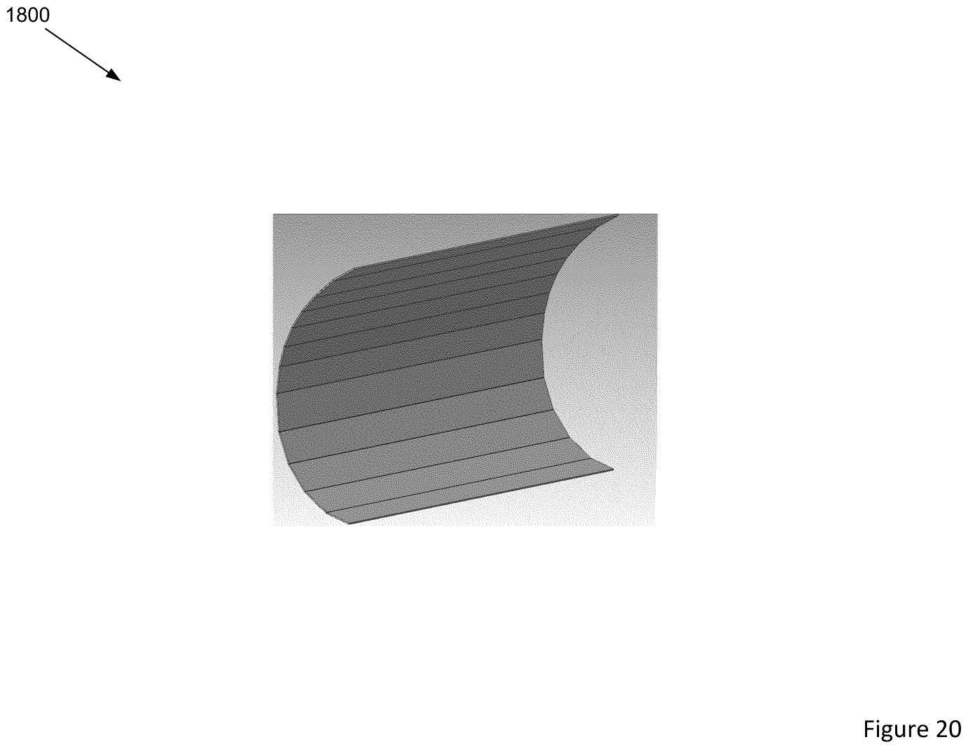

In another alternative, a cover 1800 could have an involute shape, the diameter of which is an ever increasing as it gets closer to the preferred direction to release the flow of material. This serves to slow down the material and aim it, at the same time allowing more flow into the chute as the drum spins. See FIG. 18-20.

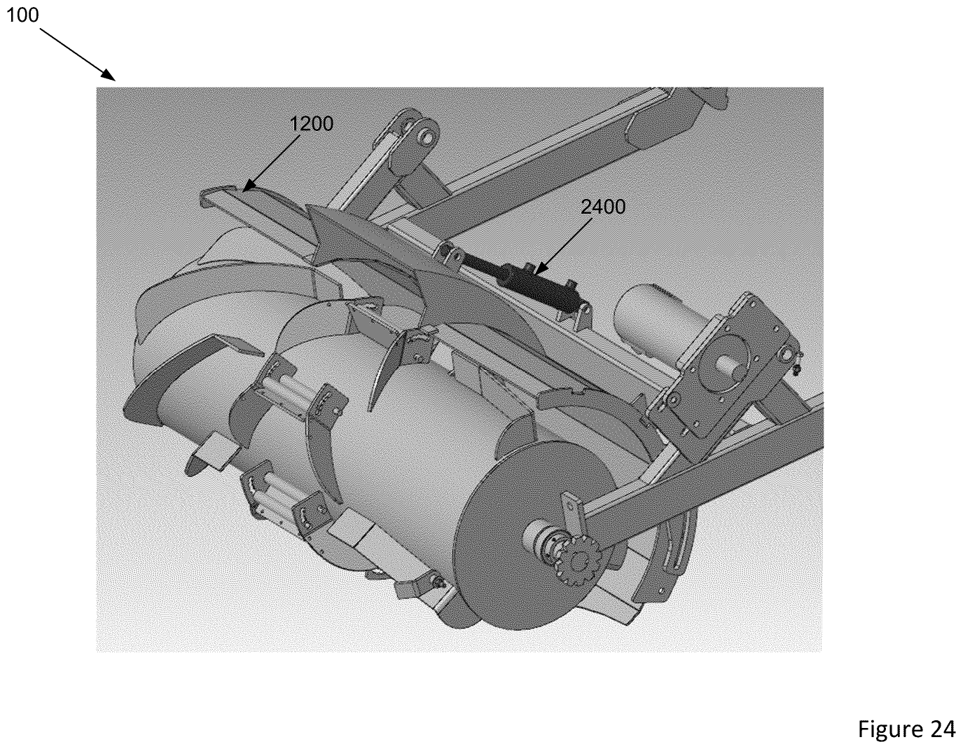

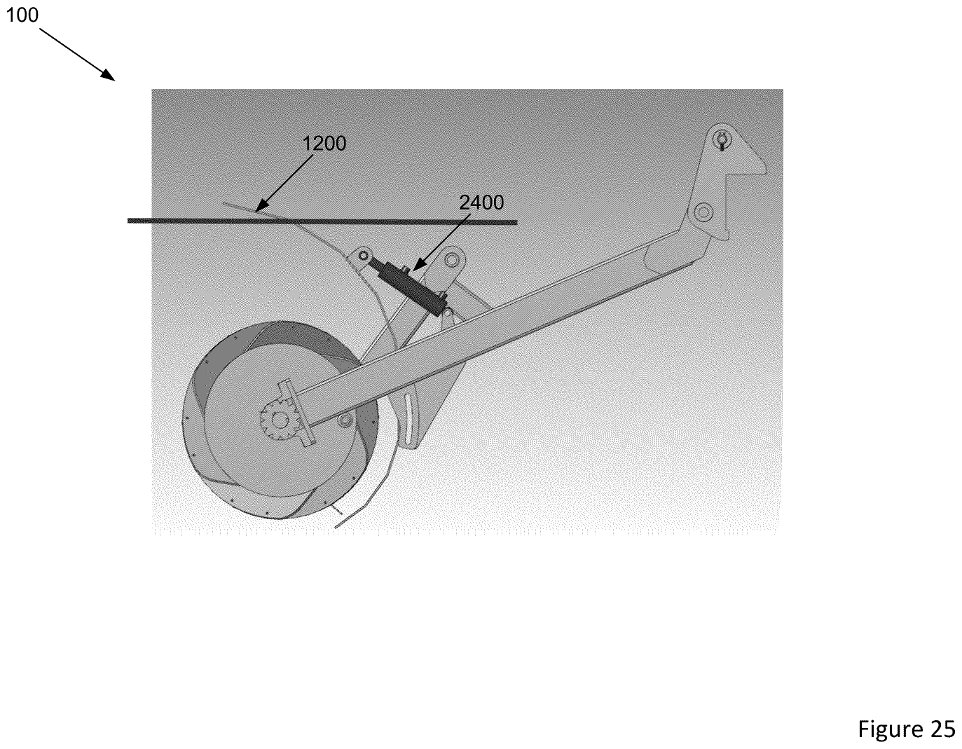

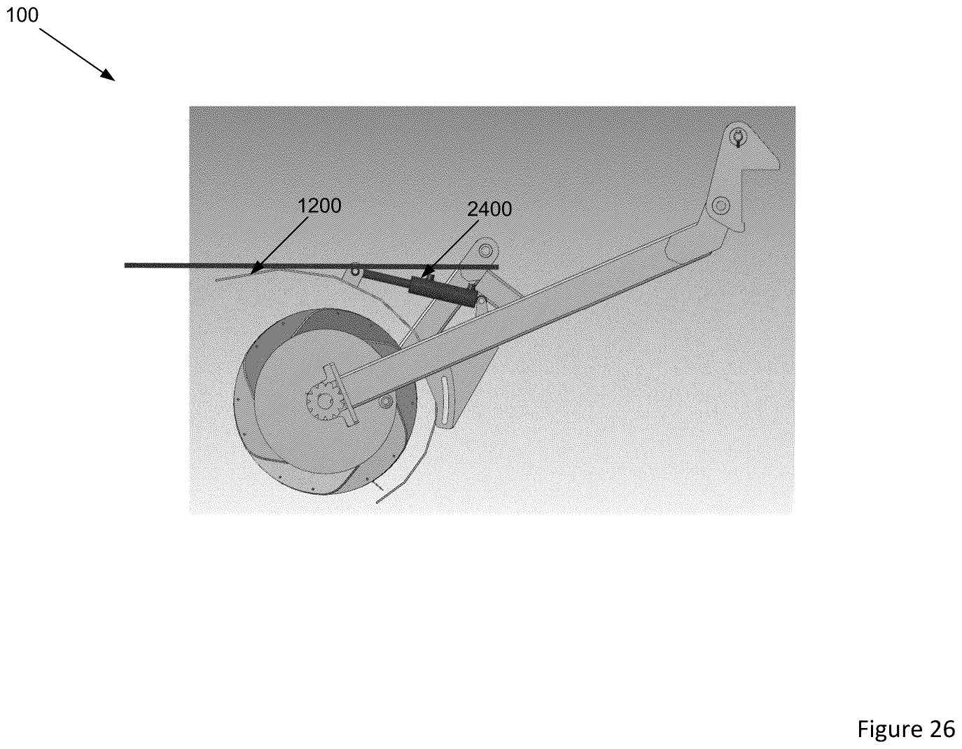

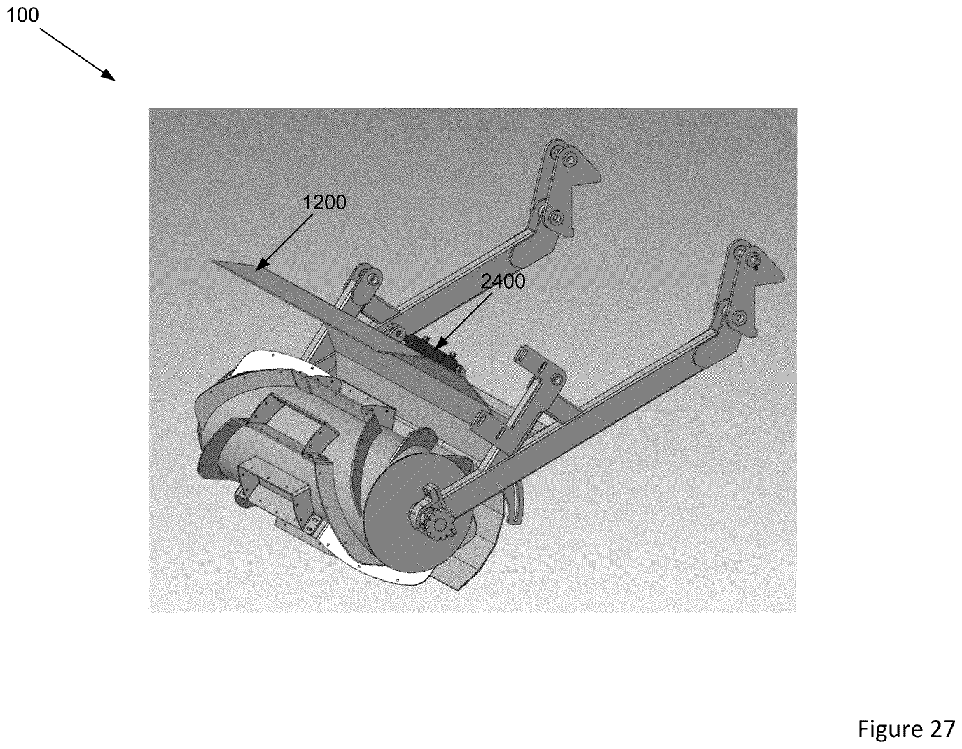

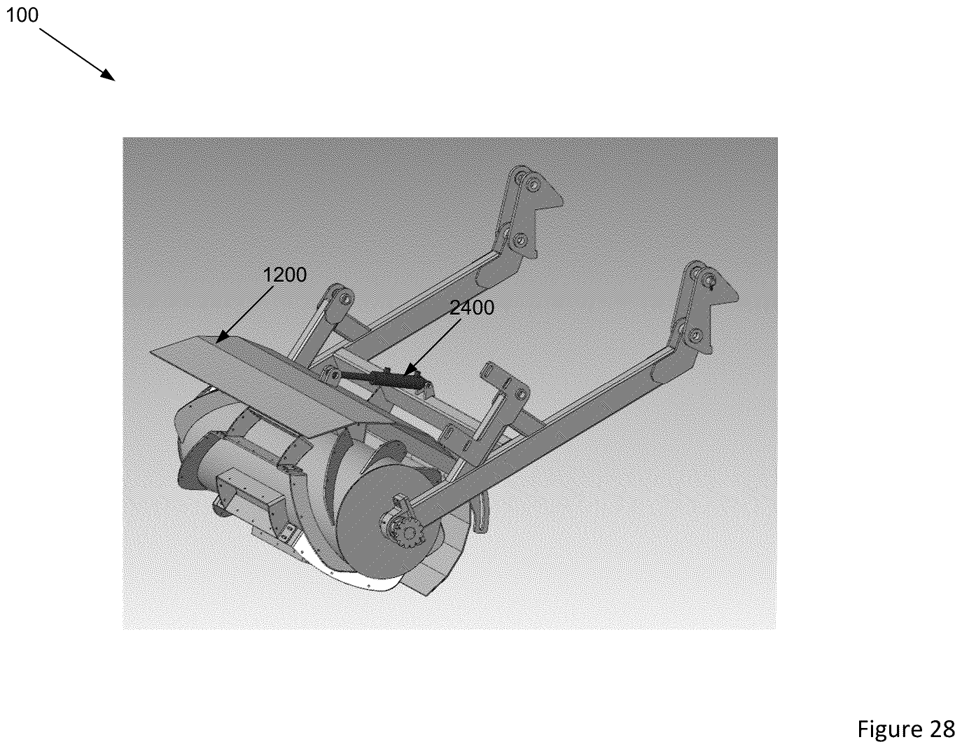

In some examples, a hydraulic cylinder 2400 actuates one or more of the covers, or portions of the cover, to change the flow pattern out of the chute. See FIGS. 24-28. The chute portion could be rotatable around a mostly horizontal or mostly vertical axis, or a combination therein. The chute may also have only a small portion of it changeable to aim or change the flow pattern. For instance, just the end of the chute could deflect up or down to interrupt the flow enough to change its direction. In another embodiment, the cover may also serve to move the forward-most portion of the cover back and out of the way, so top and front the spinning portion is not blocked by any part of the moveable cover or chute.

The current embodiment uses a combination of blades and paddles that are oriented at an angle to, and horizontally across, the spinning drum. The combination disrupts and transfers solid and liquid material towards the center to be expelled forward at the surface of the lagoon, directed at solids near the device, or thrown through the air to land away from the machine into a desired area. Other blades are oriented with the direction of the spinning drum and meant for cutting action.

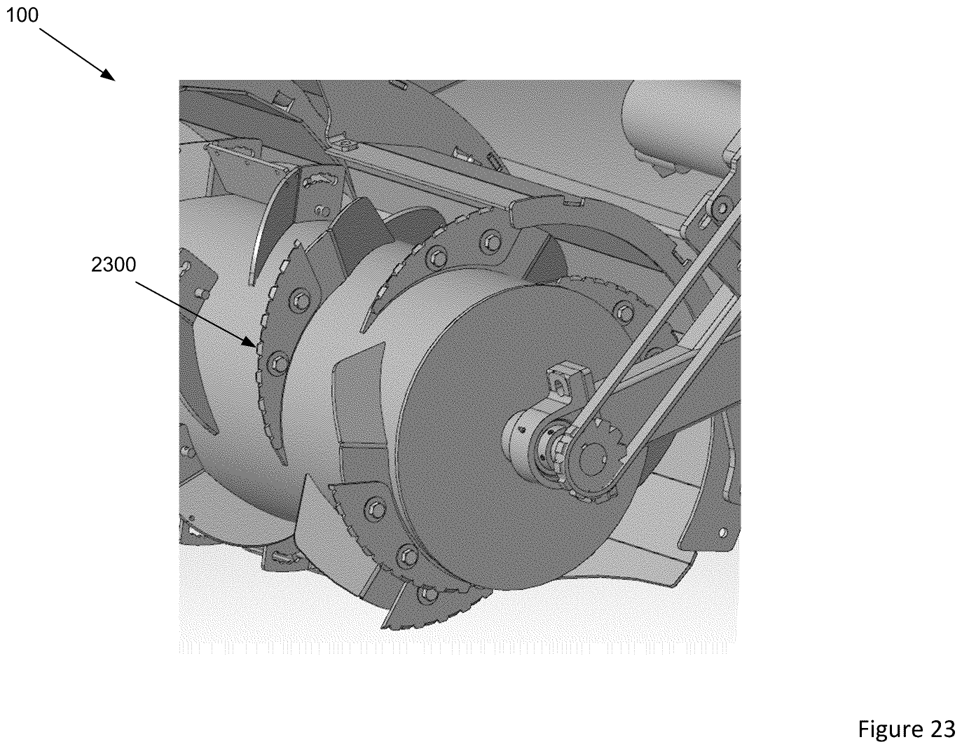

They may be sharpened or serrated to aid in the cutting. For instance, the drum can include permanently mounted or replaceable blades. These can be sharpened, made of an alternative material, or include like serrations 2300 to aid in cutting. See FIG. 23. For working softer media, it is possible to install replaceable rubber components or composite, which might wear favorably or have a weight savings.

In the instance of a manure lagoon, encountering solids and liquids, it is best to have a combination of cutting and liquid moving details attached to the spinning drum. An auger with any pitch and blade height combination is also perceived.

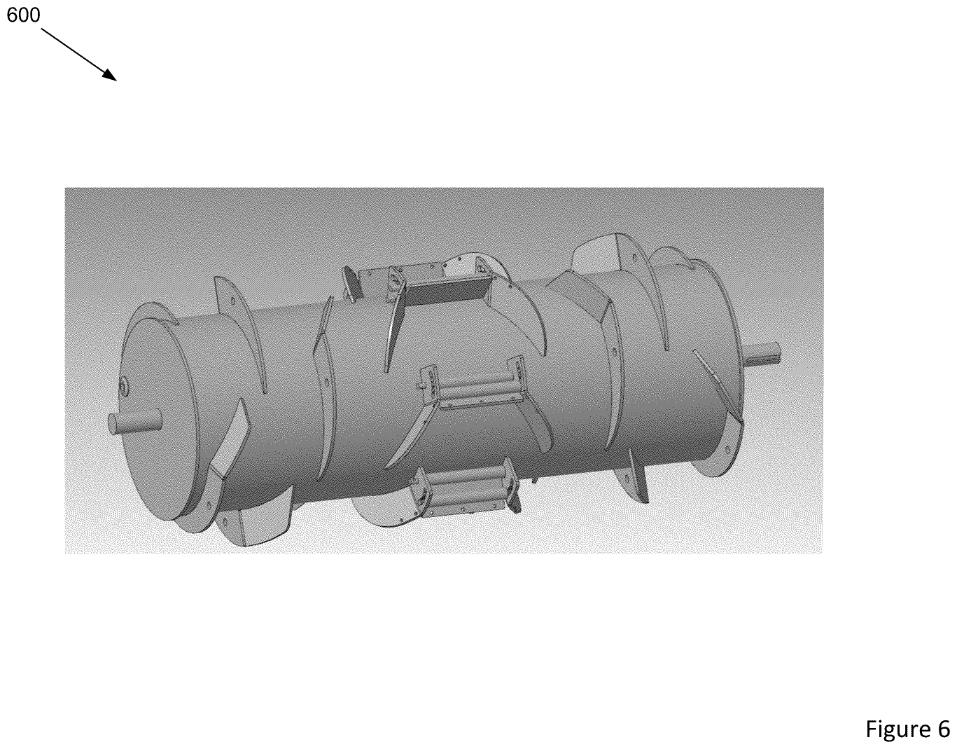

For instance, a drum 600 can be designed with more blades running in the direction of rotation, meant more for cutting through material, with the slight angle at the end serving to shift material to the sides as well to break it up. In the center, the blades run perpendicular to the direction of rotation, so they serve to scoop and project material away from the drum. See FIG. 6.

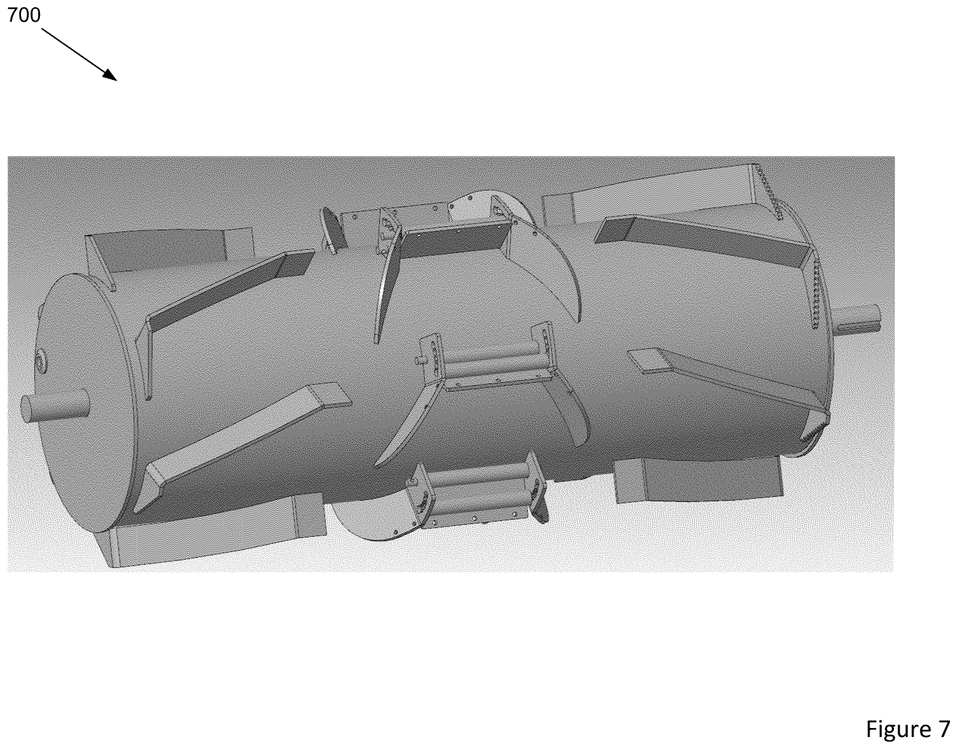

Further, a drum 700 can be designed with outer blades to start cutting on the ends, then urge material towards the centerline to be scooped and projected away. This design would bias towards projecting liquids and solids, with less cutting and slicing action. The leading edge of the outer blades could be smooth as shown on the left, sharp, or serrated. See FIG. 7.

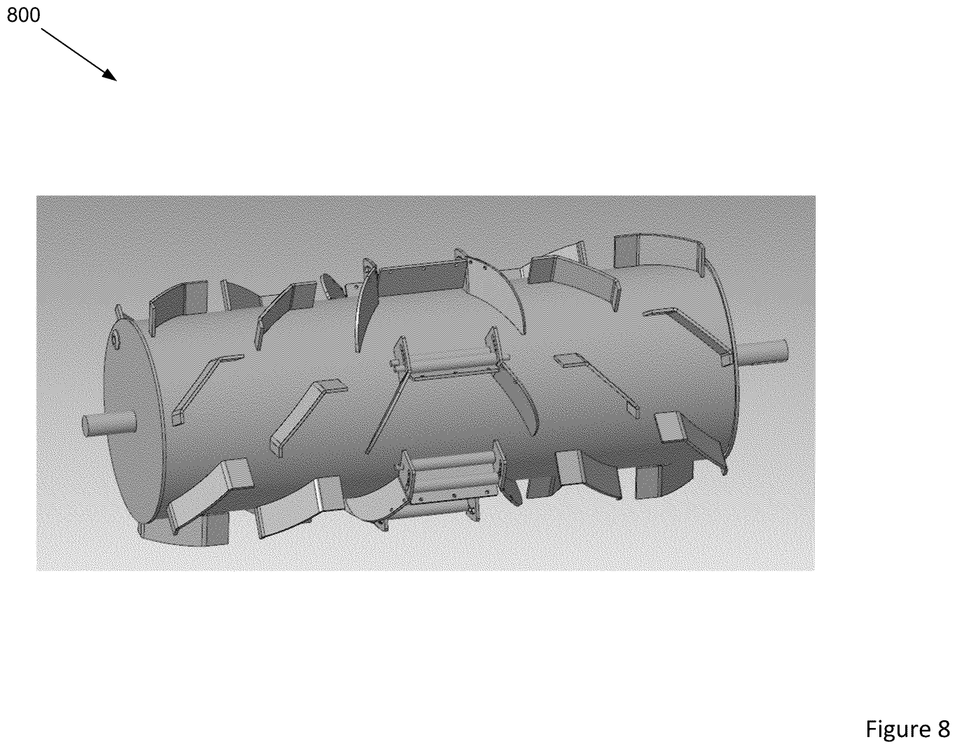

In addition, a drum 800 can be designed as a combination of mixing/cutting and projecting. There are more surfaces acting in the direction of rotation for cutting but has an angled and perpendicular portion to the outer blades to urge material to center and also project it away. The center area has more of a scoop design for projecting material away. See FIG. 8.

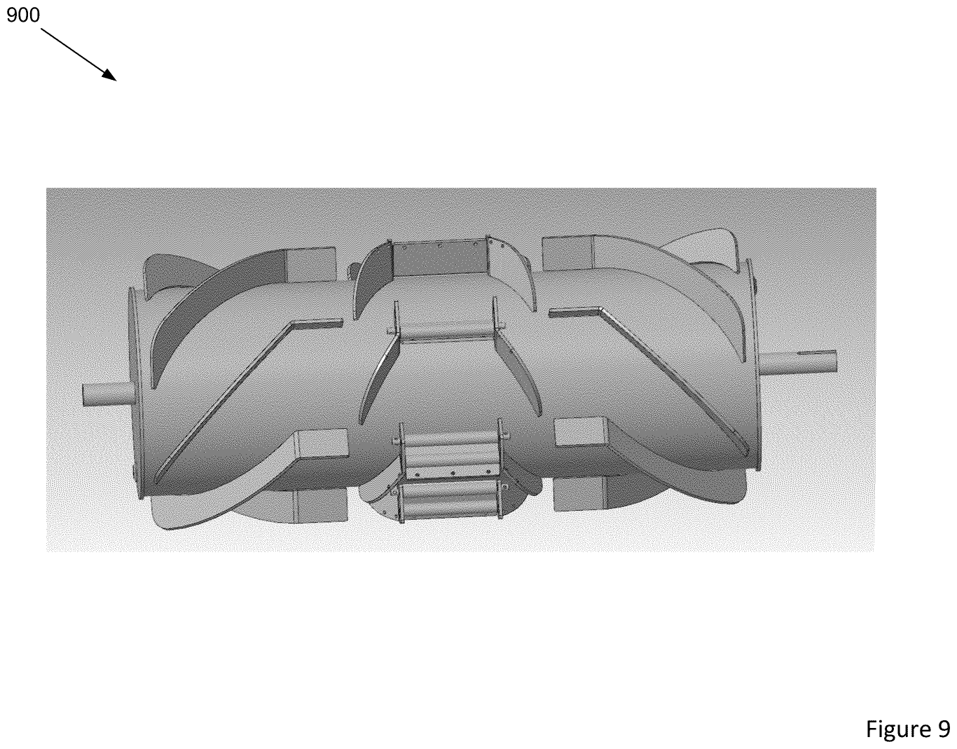

Further, a drum 900 can be designed to urge material towards center for projecting outward. The portion of the outer blades moving perpendicular to the spin direction may run entirely across centerline to act as a wide scoop for projecting material away. The slightly angled detail encourages slight cutting as it spins and moves material towards center for projecting. See FIG. 9.

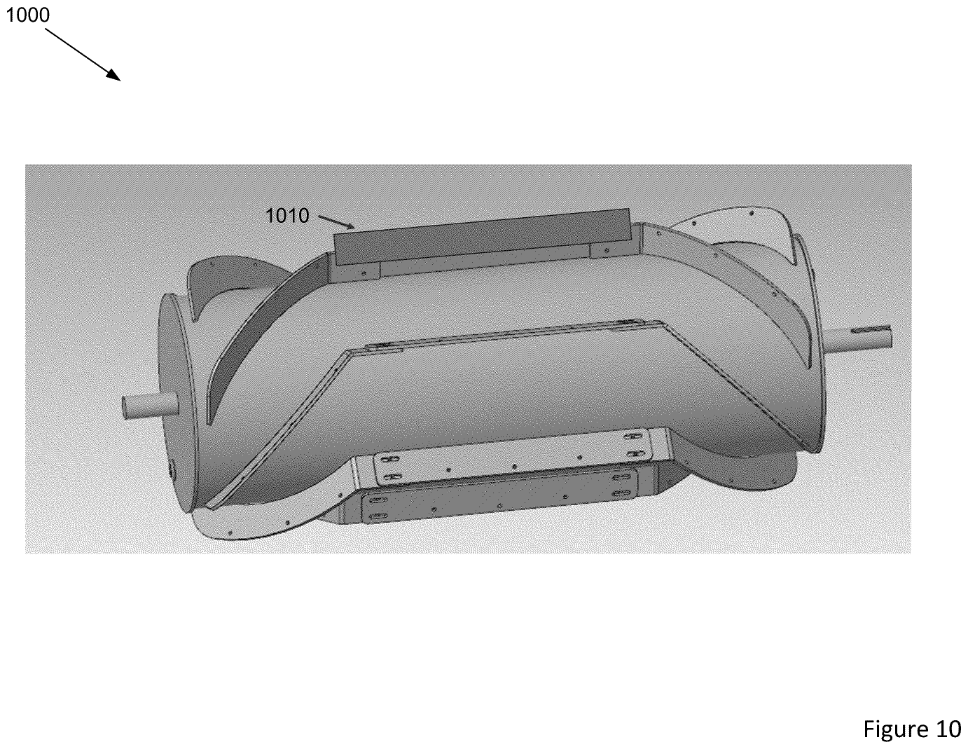

Further, a drum 1000 can be designed to break up material and move it towards the center where the change in paddle angle projects that focused material away from the spinning drum radially. The projected material direction will depend on the chute design this drum is paired with. The center paddles can be bolted on for easy replacement. Additionally, attaching an alternative material 1010 to the outer edge may be desired for improved efficiency of moving or cutting material, better wear characteristics, or different cutting action. Shapes, attachment methods, and materials may vary depending on intent of the machine. See FIG. 10.

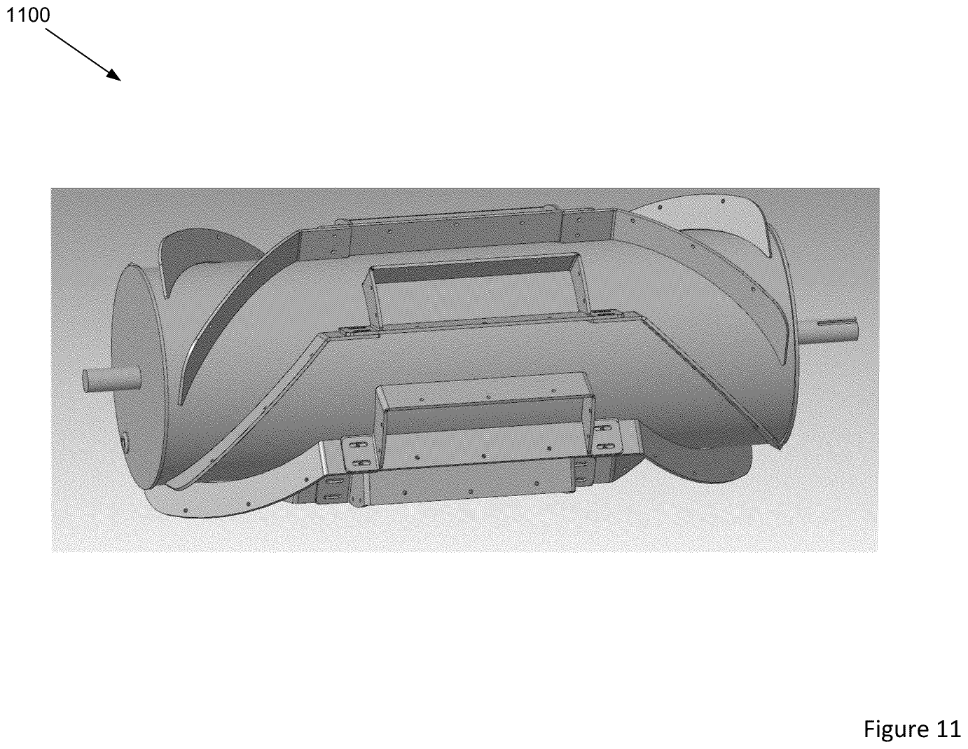

Finally, a drum 1100 can be designed to break up material and move it towards the center where the change in paddle angle projects material away from the spinning drum radially. An additional layer of center paddles can be provided for projecting material. The additional layer nearly doubles the volume of material that can be projected away for every revolution of the drum. Any number of angled or cross-paddle features can be added to change the cutting action or volume of material moved. The projected material direction will depend on the chute design this drum is paired with. See FIG. 11.

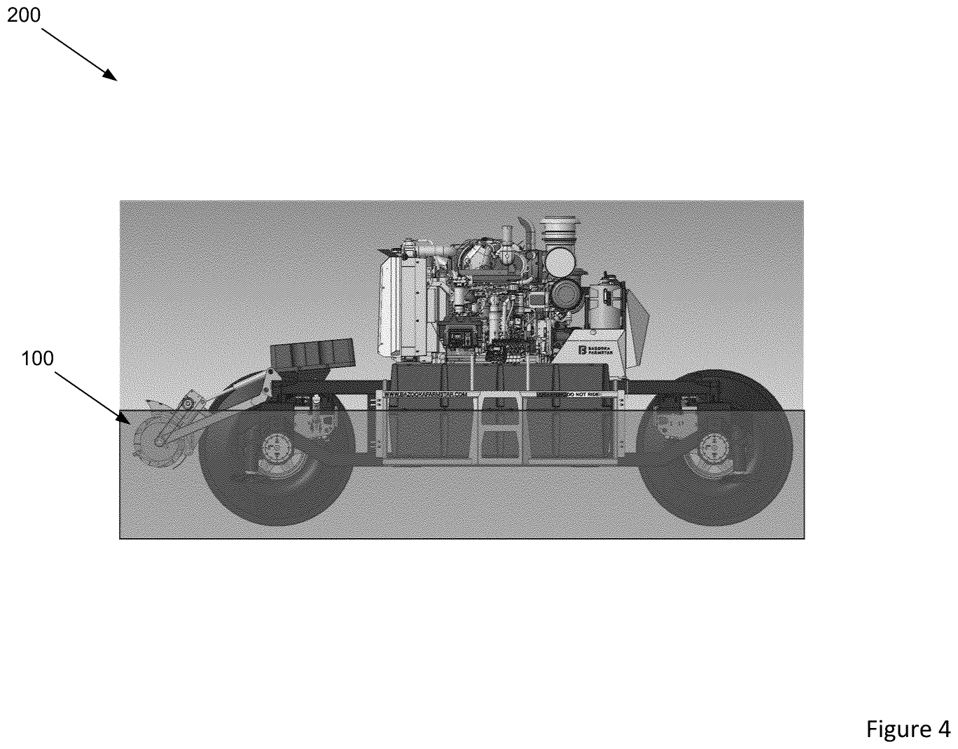

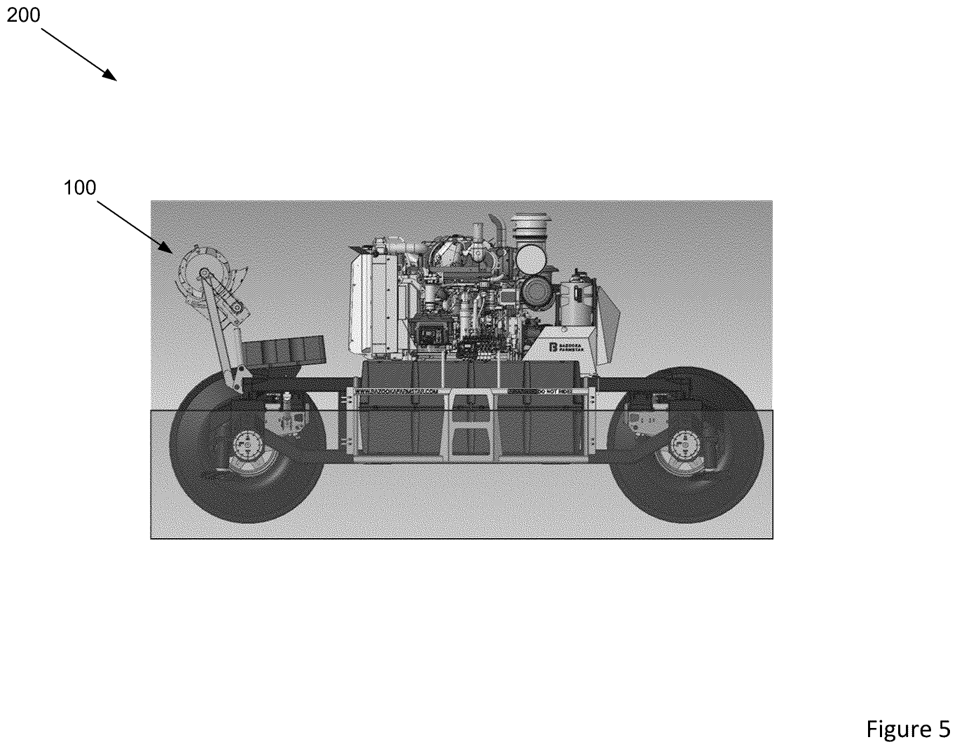

The current embodiment has the ability to raise and lower from a storage position to a point at or slightly above the point at which the tires engage the ground. See FIGS. 4-5. When in the liquid, the device can be fully submerged to act fully under the liquid causing a heavy current, or act above the liquid acting directly and only on surface solids to break them apart. The current embodiment uses a single pivot point of rotation for the raise and lower mechanism, and hydraulic cylinders provide the motive force to move the device to a desired location. It is controlled with electric over hydraulic controls, from a remote-control device away from the machine. The remote-control could include full autonomy using artificial intelligence to make decisions, partial autonomy using boundaries and constraints, or human controlled from a remote transmitting device.

The example device may be applied to liquid manure, with solid content like sand or sawdust, floating organic solids, or lagoon banks that need washdown or direct acting clearing by mechanical means like being physically broken up. The device can also be used to transfer fluid from one position to another to saturate floating solids.

This device destroys, mulches, and mixes solids with the liquid. Vertically-oriented blades (in line with rotation direction) directly cut solids. Angled blades shift solids from side to side, tearing them apart and directing their flow.

This device is able to break up or quickly melt ice that forms on lagoons or ponds. This could be accomplished mechanically or through convection by applying warmer liquid flowing over the ice.

This device can move liquid through the air or by creating current below the surface of the liquid. Blades mounted closer to perpendicular to the direction of rotation will serve to move liquid and solids better than a blade mounted in line with the direction of rotation.

The device expels liquid in a controlled way, focusing or directing material flow to a desired location. Flow can be aimed left to right up/down. Flow can be increased or decreased by submerging the system further in the liquid or changing the position of the spinning drum(s). The device can be made to only allow certain portions of the spinning drum to throw liquid/semisolids/solids and other areas to just break up or cut material.

Depending on blade orientations, it will allow a combination of flowing versus solid cutting to happen. This could be in overlapping areas of the spinning drum or separate.

The chute or flow guide that can be manipulated to aim a flow of fluid. In alternative embodiments, the chute or flow guide can include a conduit.

An aiming apparatus could include a compliant material like rubber or plastic, to eliminate the need for pivot points, rather, the aimable portion bends or folds into a variety of positions depending on where or how the operator wants material to flow.

Any power source can be used to provide motive force to the spinning drum and moveable elements of the system. For instance, hydraulic, electric, direct mechanical connection, and/or pneumatic power can be used. Internal combustion engines acting on a hydraulic system and using generated electrical power to enable all spinning and sensing components to function in this embodiment.

Spinning components could be driven using a belt and pulley/sheave, chain and sprocket, direct drive motor, wheel motor and bearing combination, planetary or gearbox mounting, torque converter or equivalent.

The device could optionally include a brake to stop the spinning momentum quickly, such as a rotor/disc brake, drum brake, band brake.

The device could be clutched to disengage the spinning drum from the power source. It could also use shear pins to isolate backlash on the power source or drive components for abrupt stops if it encounters a solid object like a rock or concrete wall. Hydraulic reliefs could also serve to stop the device from spinning or causing damage. These serve to decrease the hydraulic system pressure if there were to be a spike. This could also be achieved with hydraulic accumulators.

The current embodiment uses a single hydraulic motor, acting directly or indirectly on the spinning drum. However, dual motors or dual drivers versus a single drive could be used.

The drive can operate at variable speeds using variable speed motors, hydraulic pump flow control, electrical current, transmissions, or functional equivalents. The ability to operate at variable speeds is beneficial for chewing solids versus flinging/water movement. Depending on the attachment used, it may be optimized by operating slowly, for instance to break up solids or agitate the liquid slightly, or very quickly to throw material further or cause greater amounts of agitation in the liquid. In this embodiment, the spinning drum would benefit from operating slowly encountering higher solids material, versus high speeds when bank washing and flinging higher liquid content onto solids to soak the solids and wash it down into the lagoon.

The machine or device can be controlled by any means depending on the vehicle to which it is attached. Control from a remote transmitter such as radio, cellular, Wi-Fi, Bluetooth, or any such wireless device that sends a signal input from a remote location and allows a person to control the equipment from a safe distance. Telematics for off-site control could also be used.

Autonomous control using artificial intelligence and machine learning to seek out and destroy solids and/or agitate the lagoon can be used. Start and stop spinning depending on needs as defined by the artificial intelligence and/or machine learning. Change speeds, location and orientation can also be autonomously based on sensor inputs and decision making. Autonomous control using defined settings such as boundaries, location information, speed settings and the like can be used. Orientation of the device may change based on the settings as well. The device could follow a prescribed path or pattern or move randomly, as well as a prescribed or random motion or spinning speed of the agitation device.

Inputs from Global Positioning Satellites, Radar, Lidar, Real-Time Kinematics RTK, or equivalent could all be used to provide information to operate the machine whether through a human interface or autonomous control method. The use of sensors of any kind to assess the current status of the surrounding environment or machine operating parameters are desired for safety, maintenance, performance, or assessing whether the desired outcome has been met.

The device can be attached and oriented to the vehicle in many different ways. Raising, lowering, shifting, pivoting, in any degree of freedom may be advantageous depending on application. Actuation of said mechanisms could be with any means such as hydraulic, electric, motor, chain, or rotary positioners, servo motors, or equivalent.

The single pivot point to raise and lower the spinning drum in this embodiment could be replaced with a 4-bar mechanism, or a mechanism with any number of linkages. The benefit of more linkages would be to keep some orientation of the aiming function or cover while the apparatus is moved into position further down or up. For instance, if using a chute or aiming device attached to the cover when raising or lowering the device with a linkage mechanism, it could be beneficial to continue aiming the chute forward while the spinning portion is lowered into the liquid, so it does not require two simultaneous adjustments.

A slider mechanism to raise and lower vertically or at a prescribed angle (which could be adjustable) can be used. For instance, the spinning drum 100 can be maintained in an operating mode (see FIG. 4) when in use. A locking mechanism can be used to keep the spinning drum 100 safely in travel/storage mode when traveling through rough terrain or otherwise not being in use (see FIG. 5), and not only relying on the raise/lower function to hold. This could include lock pins, latches, hydraulic locking valve (P.O. Checks or Counterbalance valves), chains and the like.

For instance, operation modes may vary depending on the functional requirement or attachment device. For manure lagoons, if more water is needed for bank washing or projecting, partial or full submersion is beneficial. For handling floating solids, no submersion or partial submersion may enable the solids to be broken up without moving as much liquid.

The spinning apparatus may attach to a highly maneuverable pivot or slider mechanism to rotate in the vertical axis, horizontal axis, fore-aft axis, or anything in between. Improvements would include the ability to move in more than one direction, such as yaw, pitch, and roll, as well as translation up/down, side-to-side, fore/aft, or any combination thereof. Greater levels of adjustment and control over the orientation allow the device to be used in more scenarios and achieve the desired result in a more efficient way.

Control of the orientation device could be automatic. For instance, in the simplest form of pivot mechanism to raise and lower, automatic raising/lowering for bank protection is perceived for situations where driving onto the bank is required. This will ensure the device does not dig into the ground versus disrupt material resting on the ground. Sensors may be required to know if the boat is climbing a bank or sensing the bank position through known proximity sensing devices.

The device is designed with features for durability, easy maintenance, and part replacement. This could include greaseable joints, replaceable bushings, sealed joints, maintenance free materials like stainless, oil impregnated bushings, polymer, or composites.

The current embodiment uses a fully sealed and buoyant drum to which the blades are attached, to aid in the flotation of the machine and not be a hinderance to buoyancy or balance when floating. Not all applications require a floatable spinning drum.

The spinning drum could be foam filled to decrease the chance for ingress of liquid to hinder the flotation. The spinning drum could be filled with any gas, liquid, solid material, or vacuum to affect the performance and optimize the use in any application.

Alternative materials are considered for strength, hardness, weight savings, or durability. The engineering choices made with regards to materials will depend on the application of this device, what industry it is operating in, materials it encounters, maintenance requirements, safety requirements, and useful or expected life.

In alternative designs, more than one spinning drum is perceived, in varying orientations and serving a variety of functional needs. Multiple spinning heads could be used, in any number and in any orientation relative to the machine and the other spinning elements. Each cutting head could serve a different functional requirement, have different attachment combinations and operate at varying spinning speeds from one another. The attachments for different functions, for instance, could be to guide material to the middle towards another drum to then be cut or expelled. Alternatively, one spinning drum could be used to ensure no component of the device or structure encounters solid material without spinning to keep the machine moving forward and not plowing material in front of a stationary portion of the device.

The spinning drum(s) could be placed in any location around the vehicle, not just on front or back, and reorient in any number of ways.

In one functional embodiment, two or more outside horizontal or vertical heads are spinning to break up material to help solid material flow towards the middle of the unit to then get pulled down into the propeller below and incorporated into the liquid rather than being expelled through the air.

A replaceable blade system may be used. Depending on the application, replaceable blades would be advantageous for maintenance, but also changing the blades for different needs. For instance, when moving liquid is the priority versus breaking up solids. Blade replacements and or modular blades, adjustable blades, and cutters can be provided, versus liquid throwers (plus offer options or have a combination that accommodates all of those). For instance, alternate material component or replaceable section can be added to the outside of any portion of the drum for better wear, cutting, or projecting of material away from the drum. An auger and/or grinding/cutting heads or tips can also be provided on the spinning drum.

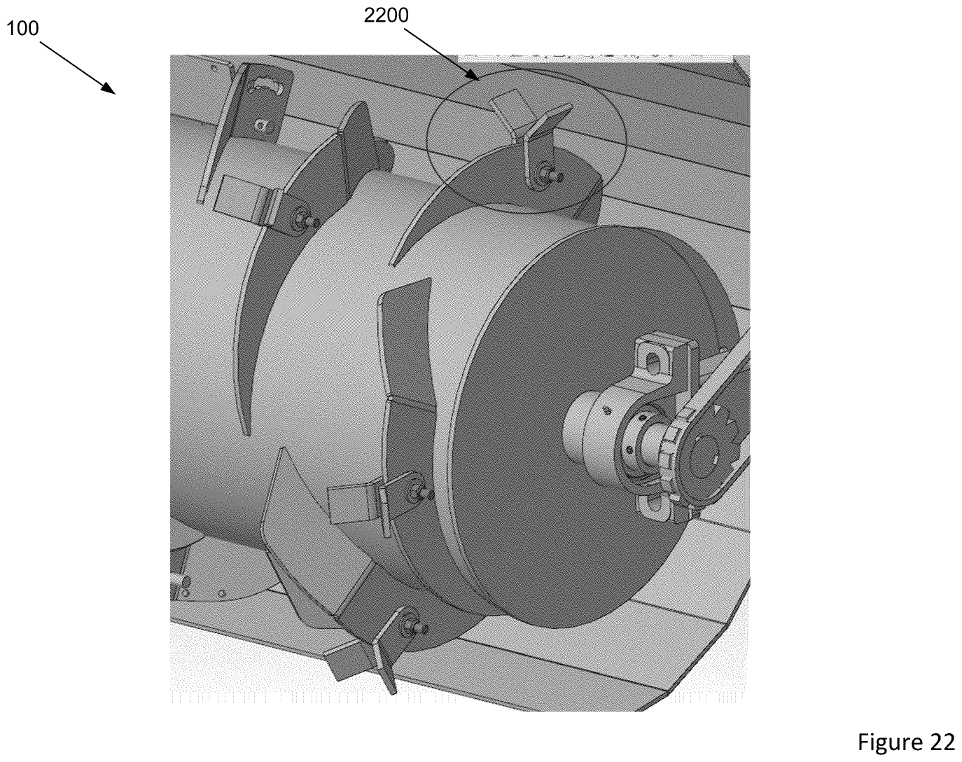

Flails 2200 (removeable or replaceable) such as a short piece of chain, blade, or weighted body, or equivalent mounted to the drum 100 that relies on centrifugal force to stay positioned outward but will move if encountering an immoveable object like a rock, pipe, wall, or the like. See FIG. 22. This could be a lighter weight polymer tine or rod for use in lighter weight and softer materials. It would bend out of the way when encountering a solid material and not apply excessive loads or cutting action to the material it is encountering.

Other options include a brush/broom attachment for sweeping and cleaning or breaking up softer materials. In addition, a skid or protections on the sides, top, and bottom to protect the ground or a bank from the spinning drum can be included. The skid hits the ground or wall first and keeps the spinning elements further away.

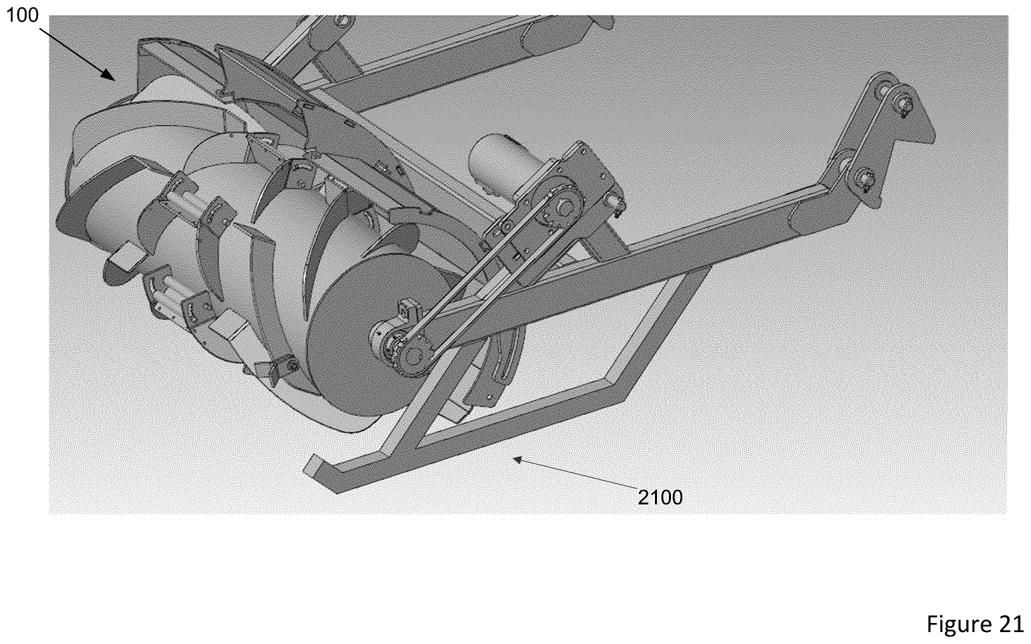

For instance, a protection skid 2100 may be separately mounted anywhere outside of the cutting diameter of the system to protect objects or this equipment from encountering the ground, hard objects or surfaces, which could cause damage. See FIG. 21. The protection device could be bolted on for replaceability, or permanently welded. It could be mounted to any side of the system to act as a stop or guard.

One potential challenge associated with adding a weighted element like the spinning drum on this vehicle is managing flotation, so the vehicle stays mostly level. This can be addressed by providing the ability to move the floating/buoyant elements of the vehicle. For instance, a mechanical float position adjustment can be provided. This can allow any floating element to shift, pivot, or move up and down to manage buoyancy of the vehicle depending on its configuration. Side floats can shift fore and aft or pivot the front/back further into the liquid as needed.

Similarly, one or more components of the floating vehicle can be positioned to manage the center of gravity and float of the vehicle in a more desirable way. Further, one or more components of the vehicle can be moveable, whether automatically or manually, to maintain level or balance of the vehicle when driving and/or floating. Many other configurations are possible.

These adjustments can be done by remote control, manual adjustment, and/or automatic sensors knowing the boat's angular position when floating. The vehicle can provide a warning or actually adjust the float positions to increase or decrease buoyancy in the location of the boat that will improve how level it floats. Warnings could signal users when there is danger of damage or safety risk.

Use of this equipment is not limited to manure lagoons. It could benefit pond clearing, fresh or salt-water bank washing, or dredging. Minor details of the spinning drum might change to move certain media or perform certain operations like a bristled brush for sweeping, cleaning or breaking up softer materials, rubber or steel snow throwing paddles, rounded stubs or sharp teeth strictly for grinding a variety of solid materials.

It is also perceived that this apparatus be customized for use in other applications such as silage cutting, compost turning, street or surface sweeping, and snow removal. Other changes to positions, orientations, materials, controls, and mechanics to accommodate each application may be required, but the concept is the same.

What is claimed is:

1. A manure lagoon agitation device comprising:
a frame configured to float in a manure lagoon
a spinning drum rotatably mounted to the frame;
blades mounted on the spinning drum, wherein at least some of the blades are oriented at an angle to direct material toward a center of the spinning drum; and
a cover positioned adjacent the spinning drum to control flow of material projected from the spinning drum.

2. The device of claim 1, wherein the cover includes a chute configured to direct the flow of material in an adjustable direction.

3. The device of claim 2, further comprising a hydraulic cylinder operably connected to the chute to adjust a position of the chute, wherein the hydraulic cylinder is configured to rotate the chute around at least one of a horizontal axis and a vertical axis.

4. The device of claim 1, wherein the blades include first blades oriented in a direction of rotation of the spinning drum for cutting material, and second blades oriented perpendicular to the direction of rotation for projecting material away from the spinning drum.

5. The device of claim 1, further comprising lift cylinders operably connected between the frame and the spinning drum, wherein the lift cylinders are configured to move the spinning drum between a storage position and an operating position.

6. The device of claim 1, wherein the spinning drum is sealed and buoyant to aid in flotation of the device.

7. The device of claim 1, wherein at least some of the blades are removably mounted to the spinning drum.

8. The device of claim 1, further comprising a protection skid mounted outside a cutting diameter of the spinning drum to protect against contact with obstacles.

9. The device of claim 1, wherein at least some of the blades comprise flails pivotably mounted to the spinning drum, wherein the flails are configured to pivot when encountering obstacles.

10. The device of claim 1, wherein the cover comprises an involute shape with an increasing diameter in a direction of material flow, and wherein the cover is configured to slow and aim material projected from the spinning drum.

11. A method of agitating material in a manure lagoon comprising:
rotating a spinning drum mounted to a frame, wherein the spinning drum includes a plurality of blades;
directing material toward a center of the spinning drum using angled blades mounted on the spinning drum; and
controlling flow of material projected from the spinning drum using a cover.

12. The method of claim 11, further comprising:
adjusting a position of a chute on the cover to direct the flow of material in a desired direction; and
actuating a hydraulic cylinder connected to the chute to rotate the chute around at least one of a horizontal axis and a vertical axis.

13. The method of claim 11, further comprising:
cutting material using first blades oriented in a direction of rotation of the spinning drum; and
projecting material away from the spinning drum using second blades oriented perpendicular to the direction of rotation.

14. The method of claim 11, further comprising moving the spinning drum between a storage position and an operating position using lift cylinders operably connected between the frame and the spinning drum.

15. The method of claim 11, further comprising:
operating the spinning drum at a first speed for breaking up solids; and
operating the spinning drum at a second speed higher than the first speed for projecting liquid material.

16. The method of claim 11, further comprising:
submerging the spinning drum to a first depth for breaking up floating solids; and
submerging the spinning drum to a second depth greater than the first depth for moving liquid material.

17. The method of claim 11, further comprising:
protecting against contact with obstacles using a protection skid mounted outside a cutting diameter of the spinning drum; and
allowing flails pivotably mounted to the spinning drum to pivot when encountering the obstacles.

18. The method of claim 11, further comprising:
slowing material projected from the spinning drum using an involute-shaped cover with an increasing diameter in a direction of material flow; and
aiming the slowed material using the involute-shaped cover.

19. The method of claim 11, further comprising:
automatically adjusting a position of the spinning drum when approaching a bank of the manure lagoon using sensor inputs; and
controlling operation of the spinning drum based on the sensor inputs.

20. The method of claim 11, further comprising breaking up ice formed on the manure lagoon by at least one of mechanical action of the spinning drum and applying warmer liquid flowing over the ice.
